(19) United States
(12) Patent Application Publication
(10) Pub. No.: US 2007/0282948 A1
(43) Pub. Date: Dec. 6, 2007

(54) Interactive Presentation Method and System Therefor

(75) Inventors: Marcello Praino, Elmsford, NY (US); Jason M. Goldklang, New York, NY (US); Robert J. Blink, Fort Lee, NJ (US); Jennifer Bryan, Norwalk, CT (US)

Correspondence Address: ANDREWS & KURTH, L.L.P., 600 TRAVIS, SUITE 4200, HOUSTON, TX, 77002, US

(73) Assignee: Hudson Intellectual Properties, Inc.

(21) Appl. No.: 11/422,497

(22) Filed: Jun. 6, 2006

(51) Int. Cl. G06F 15/16

(52) U.S. Cl. 709/204

(57) ABSTRACT

A method and apparatus for use in presentations, lectures, seminars, and similar applications that preferably includes an application server computer that runs an interactive presentation facilitating software application and that is connected via a network to a presenter computer and to a number of client computers. The application server computer retrieves presentation slides stored in a database and broadcasts the slides for display at the presenter computer, on an overhead screen, and at each client computer. User notes entered at the client computers are transmitted to the application server computer for storage in the database. The notes are keyed to the presentation slide being displayed as the notes are entered, so that they can later be provided to each note taker in correlation with the slide presentation. Each audience member's personal notes and the slides may be later transmitted by the application server computer to the audience member.

### BACKGROUND OF THE INVENTION

1. Field of the Invention

This invention relates generally to an interactive presentation system and method and specifically to a local client-server system with software application useful for facilitating audience note taking and interaction during slide presentations to numerous participants present threat.

2. Description of the Prior Art

One of the greatest improvements for both presenters and their audiences is the combination of low cost computer software which simplifies and expedites the development of colorful and professional-looking presentation slides and low-cost electronic visual systems for displaying the slides on a large screen to an audience. This technology has revolutionized the manner in which presentations are commonly given. Often, paper printouts of the slides displayed during the presentation are first provided to the audience for their keeping to memorialize the presentation. It is common practice for members of the audience to add handwritten notes to these slide printouts to capture their own thoughts are they occur during the presentation.

Other advancements include the ability to email or post on the world wide web for downloading the personalized files containing the slides used in the presentation for later retrieval and use by the audience. This technology can reduce the cost and hassle of the presenter providing paper copies of the slides to a large audience. Unfortunately for the audience, when slide printouts are not provided for use during a presentation, it is more difficult for a note taker to key a given thought to the material present on the slide being displayed when the thought occurred. Instead of having the contents of the slide on the paper to which the notes can be added, the note taker has a blank sheet of paper to which key points from the slide must be added. The slide information which must be duplicated in the notes is referred to as note taking overhead. Note takers may not consistently record the note taking overhead, and the additional effort required to do so may distract the note taker, causing him to miss other points raised during the presentation. Thus, it is desirable to have a paperless system which allows a user to take notes which are automatically tied to the slide shown as thoughts occur.

An interactive speaker training system is known in the art which video records the speaker. Each member of the audience has a computer device which allows the user to input his or her thoughts. These notes are recorded and are time stamped to the recorded video. Thus, a member of the audience may later review the captured video presentation, and his or her notes will appear on the video screen at the same instant of the presentation where they were originally recorded. Unfortunately, such a system may require the user to listen to the entire lecture each time her or she wishes to access the notes. As lectures may be lengthy, such use may not be suitable for a subsequent brief review of the material. An electronic system which keys a note taker's notes to the presenter's slides, rather than a video stream of the presentation, is desirable; such a system would allow the gist of the speaker's entire presentation, together with the note takers comments, to be easily printed at a later time in a format more suitable for a quick review of the material.

3. Identification of Objects of the Invention

A primary object of the invention is to provide a method and system to facilitate interactive presentations by providing for electronic note taking by each member of the audience for which the notes are later retrievable, for example, over the internet, and in which the notes are tied to the slide being displayed when the notes were entered by the member.

Another object of the invention is to provide a method and system which provides real-time feedback from the audience to the presenter, particularly with regard to the audience's level of understanding and interest of the material being presented.

Another object of the invention is to provide a system which can support up to several hundred concurrent participants.

Another object of the invention is to provide a method and system which enables each member of the audience to view and participate in the presentation using interactive features, including electronically asking the presenter a question, requesting further information or samples, and viewing references or upcoming events.

Another object of the invention is to provide a method and system which can record, process, sort and retrieve user data for a presentation including each audience member's interest and understanding on a slide-by-slide basis and each member's average interest and understanding levels for the entire presentation.

Another object of the invention is to provide a method and system which can record, process, sort and retrieve presentation data including the audience's average interest and understanding levels for each slide in the presentation and audience questions and comments on a slide-by-slide basis.

Another object of the invention is to provide a method and system where the entire system runs in a closed stand-alone network environment, independent of the internet.

### SUMMARY OF THE INVENTION

The features identified above, as well as other features of the invention are incorporated in a method and apparatus for use in presentations, lectures, seminars, and similar applications. According to one embodiment, the interactive presentation system is a custom client-server application that is designed and arranged for use in presentations, lectures, seminars, and similar applications generally, but not necessarily, where the audience is present in the same room as the lecturer or presenter. For example, interactive presentation system is particularly suited for pharmaceutical product presentations.

The interactive presentation system preferably includes a high-capacity application server computer that runs an interactive presentation facilitating server software application and that is connected via a local network to a presenter computer, administrative computers, and to a number of client computers. In response to control commands entered at the presenter computer, the application server computer retrieves presentation slides stored in a database and broadcasts the slides for display at the presenter computer, on an overhead screen, and at each client computer. The application server computer receives questions, comments and other feedback or requests entered by the audience members at the client computers and stores them in the database. Audience questions and comments are also transmitted by the application server computer to the presenter computer, preferably via an administrator computer, so that the presenter or lecturer can see and address the questions or comments as they appear during the presentation. Audience feedback pertaining to levels of understanding and interest are collected at the user computers and statistically analyzed by the application server computer. The user feedback analysis results are transmitted to the presenter computer so that the presenter or lecturer can assess the effectiveness of the presentation as it progresses. Additionally, other requests by audience members, such as for samples, materials, or additional information on references or upcoming events, are stored in the database and then either marked for later action or processed immediately by application server computer. Furthermore, user notes entered at the client computers are transmitted to the application server computer for storage in the database. The notes are tied to the presentation slide being displayed as the notes are entered, so that they can later be provided to each note taker in correlation with the slide presentation. Each audience member's personal notes and the slides may be later transmitted by the application server computer to the audience member, for example by saving to a universal serial bus storage device at the client computer, by email, or by posting to a website for later download.

The application server computer may also function as a database server for the database. However, a dedicated database server may be used. The database server preferably uses a relational database management system for the purpose of storing user account data, presentation slides, user feedback, user request data, and user notes, and for transmitting that data to the various computers over the network.

An administrative manager computer, which may be separate from or integral with the application server computer, communicates with the database to selectively retrieve user or presentation data or store user data.

### BRIEF DESCRIPTION OF THE DRAWINGS

The invention is described in detail hereinafter on the basis of the embodiments represented in the accompanying figures, in which:

FIG. 1 is a schematic diagram which illustrates a system according to a first embodiment of the invention for facilitating an interactive slide presentation to a local audience including a number of client workstations or computers, preferably one for each member of the audience, a presenter workstation or computer for use by the presenter, and an applications server computer which also functions as an administrator workstation or computer for use by the system administrator and as a database server;

FIG. 2 is a schematic diagram which illustrates a system according to a second embodiment of the invention which is a variant of the system of FIG. 1 wherein the application server computer, database server, and administrator workstation or computer are all separate and dedicated machines;

FIG. 3 illustrates a user interface to a client workstation or computer of FIG. 1 for use by a member of the audience for interacting with a presentation by presenting questions or comments to the presenter in electronic format and by recording notes for later retrieval and use by the member;

FIG. 4 illustrates a user interface to the presenter workstation or computer of FIG. 1 for use by the presenter for receiving feedback, questions and comments from the audience and for controlling the slide presentation;

FIG. 5 illustrates a user interface to the administrator workstation or computer of FIG. 1 for use by the administrator in managing the interactive presentation system during the slide presentation;

FIG. 6 illustrates a user interface to the administrator workstation or computer of FIG. 1 for use by the administrator in performing pre and post-presentation system management, including establishing user accounts and obtaining summary reports of the presentation and user activity;

FIG. 7 is a simplified schematic flowchart illustrating one possible embodiment of the structure of software, and the functionality inherent therein, for a client computer or workstation of the presentation systems of FIGS. 1-2 and corresponding to the user interface of FIG. 3;

FIG. 8 is a simplified schematic flowchart illustrating one possible embodiment of the structure of software, and the functionality inherent therein, for a presenter computer or workstation of the presentation systems of FIGS. 1-2 and corresponding to the user interface of FIG. 4 and the flowchart of FIG. 7;

FIG. 9 is a simplified schematic flowchart illustrating one possible embodiment of the structure of software, and the functionality inherent therein, for a administrator computer or workstation of the presentation systems of FIGS. 1-2 and corresponding to the user interface of FIG. 5 and the flowcharts of FIGS. 7-8; and

FIG. 10 is a simplified schematic flowchart illustrating one possible embodiment of the structure of software, and the functionality inherent therein, for a server computer or workstation of the presentation systems of FIGS. 1-2 and corresponding to the flowcharts of FIGS. 7-9.

### DESCRIPTION OF THE PREFERRED EMBODIMENT OF THE INVENTION

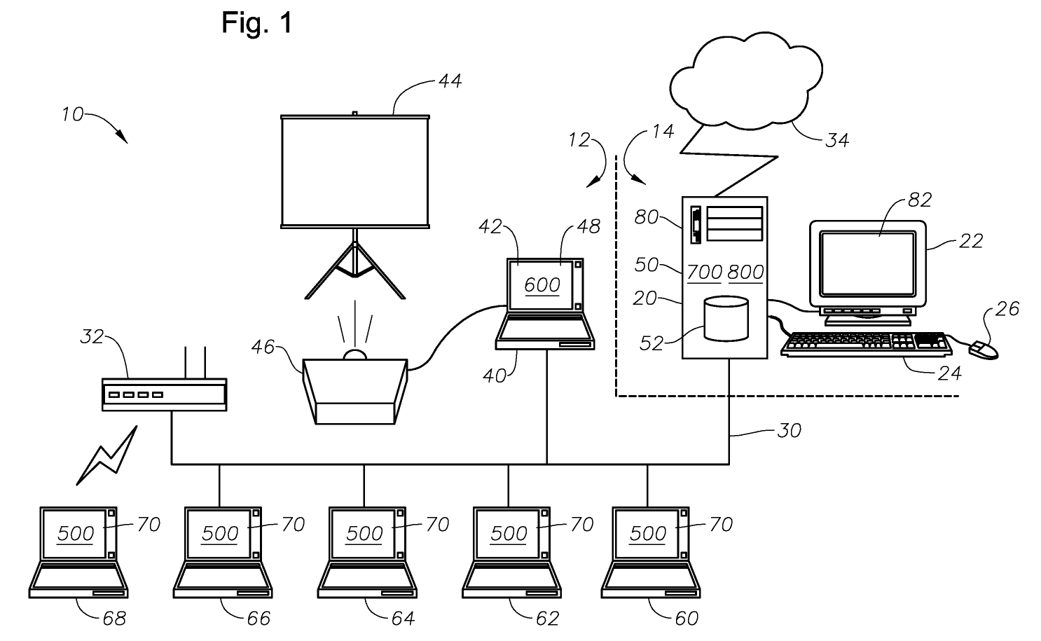

FIG. 1 illustrates the interactive presentation system 10 according to a first embodiment of the invention. The interactive presentation system 10 is preferably a custom client-server application that is designed and arranged for use in presentations, lectures, seminars, and similar applications generally, but not necessarily, where the audience is present in the same room 12 as the lecturer or presenter. For example, interactive presentation system 10 is particularly suited for pharmaceutical product presentations, but it may be used for any similar function.

The interactive presentation system 10 includes an application server computer 20 running application server software 800. Application server 20 may be located in the same room 12 as the presentation, or as illustrated in FIG. 1, it may be located in a separate room 14, provided it is within local network range of presentation room 12. The application server computer 20 is preferably connected via a local network 30 to a presenter computer or workstation 40 running presenter computer software 600 and to a number of client computers or workstations 60, 62, 64, 66, 68, each running an independent instance of client computer software 500. The presenter computer or workstation 40 and the client computers or workstations 60, 62, 64, 66, 68 are preferably located in the presentation room 12, with the presentation computer 40 disposed at a location for easy access by the presenter or lecturer during the slide presentation and with the client computers 60, 62, 64, 66, 68 disposed for convenient use by the audience members during the slide presentation.

Although any suitable network technology may be used to implement the local network 30, it is preferably constructed using, at minimum, a fully switched 100 Mbps ethernet network with support for the Transmission Control Protocol/Internet Protocol (TCP/IP) network protocol. Network routing is preferably handled by a high-capacity network router (e.g., Cisco/Foundry) configured for local Internet Protocol (IP) addressing for up to 500 local IP addresses. The local network 30 may be hardwired, wireless, or as illustrated in FIG. 1, a combination thereof. FIG. 1 illustrates client computers 60, 62, 64, 66 being hardwired to network 30. A wireless base station 32 is also hardwired to network 30, and it communicates with client computer or workstation 68 using a suitable wireless protocol, e.g. 802.11(b) or 802.11(g).

Application server computer 20, presenter computer or workstation 40, and the client computers or workstations 60, 62, 64, 66, 68 may each be a personal computer, a workstation computer, laptop computer, handheld computer, minicomputer, mainframe, or some other type of computer, as appropriate. As is well known in the computer field, each computer 20, 40, 60, 62, 64, 66, 68 preferably contains a processor which processes instructions retrieved from a memory device to control the reception and manipulation of input data, the transfer of data to other computers, and the output and display of data on output devices. Preferably, a memory bus is used by the processor to access random access memory (RAM), read only memory (ROM), or other memory. Memory is used for storing input data, processed data, and software in the form of instructions for the processor. The processor uses a peripheral bus to access input, output and storage devices, preferably including a display monitor, floppy disk drive, compact disc drive (e.g. CD-ROM), hard disk drive, input keyboard, mouse, printer, universal serial bus (USB) memory device, and network interface. Each computer 20, 40, 60, 62, 64, 66, 68 includes an operating system such as Linux®, Unix®, Windows®, or Macintosh® Operating System to control computer resources and peripherals and the execution of software computer code. The software code may reside in RAM, ROM, hard disk drive, CD-ROM, floppy drive or other storage medium. Additionally, the software may be stored at a separate computer and accessed over a network. As this general computer technology is commonplace and well understood in the art, it is not discussed further herein.

The application server computer 20 is preferably a high-capacity computer server system which runs the interactive presentation facilitating server software application 800 according to an embodiment of the invention. Application server computer system 20 is ideally sufficiently capable to support several hundred concurrent client connections. Application server computer 20 is shown in FIG. 1 equipped with a display monitor 22, input keyboard 24, and input mouse device 26. In addition to the local network 30 connection, application server computer 20 is preferably connected to an external network 34, usually the internet. Application server computer 20 may act as a gateway, proxy server and/or firewall for selectively and securely allowing the presentation computer 40 and client computers 60, 62, 64, 66, 68 access to the external network 34, and vice versa.

The application server computer 20 functions by listening for connections made by authorized client computers 60, 62, 64, 66, 68 over the local network 30 and by transmitting data between computers over the local network 30 or external network 34. First, in response to control commands entered at presenter computer or workstation 40 by the presenter or lecturer, the application server computer 20 preferably retrieves presentation slides stored in database 52 and broadcasts the slides for display at the presenter user interface 42 of presenter computer 40, on screen 44 by liquid crystal display (LCD) projector 46, and at the client user interface 70 of each client computer 60, 62, 64, 66, 68. Second, the application server computer 20 receives questions, comments and other feedback or requests entered by the audience members at the client computers 60, 62, 64, 66, 68, processes the audience-generated data, and stores it in database 52. Audience questions and comments are then transmitted by application server computer 20 to presenter computer 40 for display at presenter user interface 42 so that the presenter or lecturer can see and address the questions or comments as they appear during the presentation. In one embodiment, however, the audience questions and comments are first sent to an administrator computer 80, where a moderator selects, edits and forwards questions and comments to the presenter computer 40. The audience feedback pertaining to levels of understanding and interest are statistically analyzed by application server computer 20, and the analysis results are transmitted to the presenter computer 40 for display at the presenter user interface 42 so that the presenter or lecturer can assess the effectiveness of the presentation as it progresses. Other requests by audience members, such as for samples, materials, literature, or additional information on references or upcoming events, are stored in database 52 and either marked for later action or processed immediately by application server computer 20. Third, user notes entered at the client computers 60, 62, 64, 66, 68 are transmitted to the application server computer 20 for storage in database 52. The notes are tied to the presentation slide being displayed as the notes are entered, so that they can later be provided to each note taker in correlation with the slide presentation. Preferably, each audience member's personal notes are later transmitted by the application server computer 20 to the audience member over the internal network 30, such as by downloading to a universal serial bus (USB) storage device, or over an external network 34, such as by email, by a file transfer protocol (FTP) service, or by posting on an internet site for secure downloading using an internet browser software application.

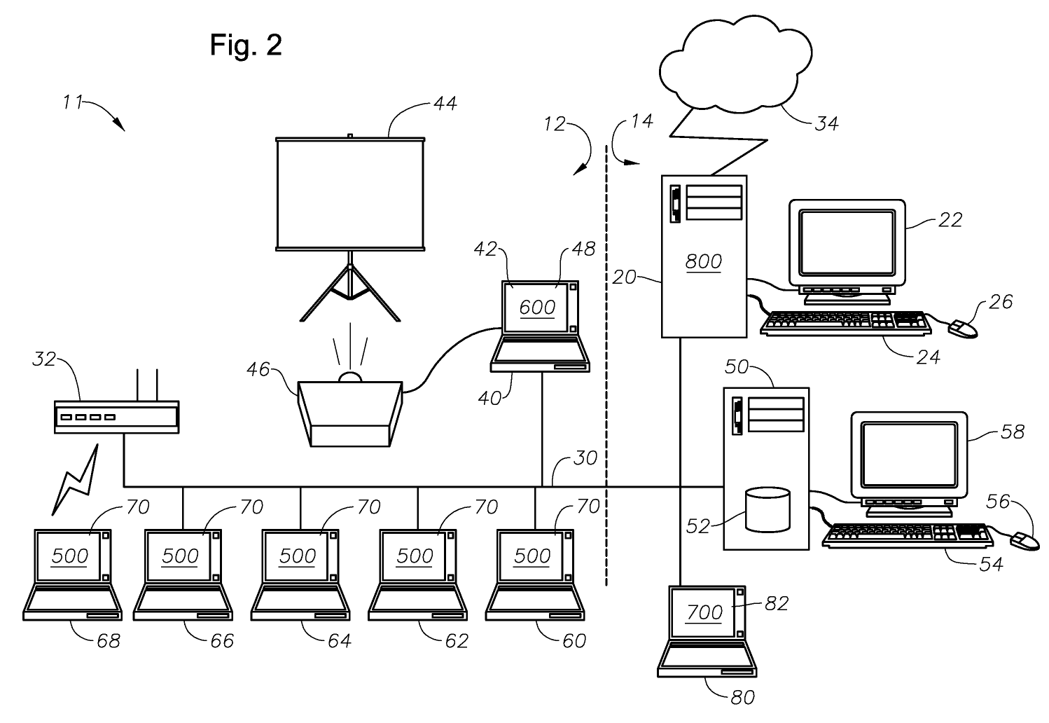

As illustrated in FIG. 1, the application server computer 20 also functions as a database server 50 for database 52. Database server 50 preferably uses a relational database management system (RDBMS) for the purpose of storing user account data, presentation slides, user feedback, user request data, and user notes, and for transmitting that data to various computers over the local network 30 and external network 34. However, with a large number of concurrent client connections, to enhance scalability and performance it may be preferable to host database 52 on a dedicated database server 50, such as with the embodiment of system 11 as illustrated in FIG. 2.

In FIG. 1, the application server computer 20 also performs the role of an administrative manager computer or workstation 80 by running administrator computer software 700 and hosting an administrator user interface 82. The administrative manager computer 80 communicates with database 52 to selectively retrieve user or presentation data for display at the administrator user interface 82 and to store user account information, entered at administrator user interface 82, in database 52. As shown in FIG. 2, administrator computer or workstation 80 may also be hosted on a different machine than the application server computer 20, if desired.

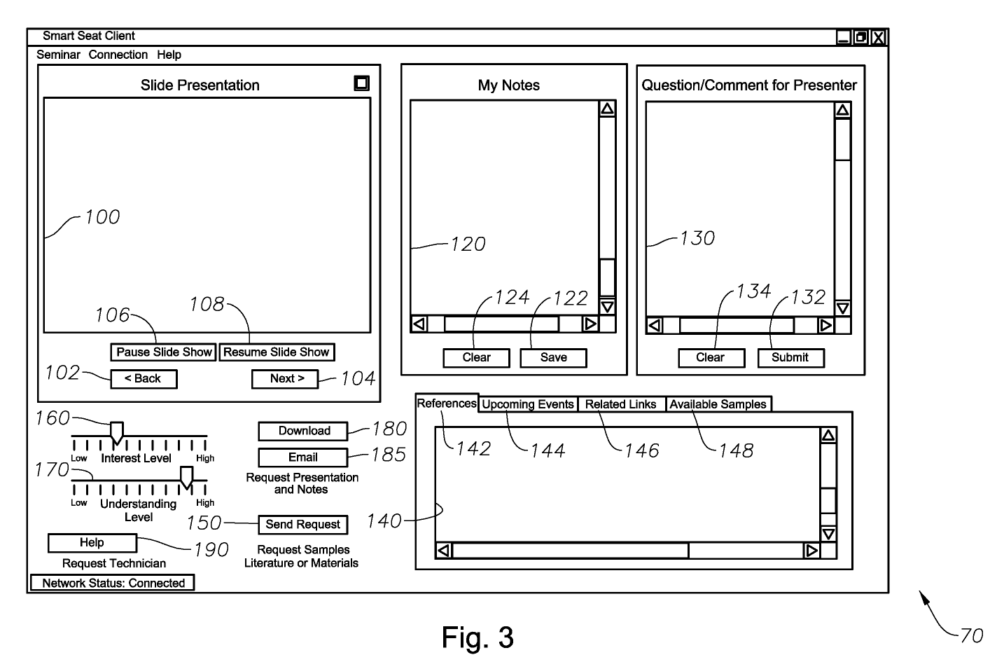

Referring to FIG. 1, the client computers 60, 62, 64, 66, 68, are preferably laptop computers or handheld computers. Each member of the audience preferably has a dedicated client computer for use during the presentation. Each client computer 60, 62, 64, 66, 68 ideally runs an individual instance of a client software application 500 that generates a client user interface 70. The client user interface 70 contributes to the audience member's presentation experience by enabling the audience member to view and participate in the presentation using several interactive features, discussed below with reference to FIG. 3. The client software application first preferably presents each audience member with a login screen (not shown) prompting the user for a username and password or other identifier. Once a member is logged on, the software 500 preferably presents a pending mode display screen while waiting for the presentation to commence, or will display the client user interface 70 with the current presentation slide displayed thereon if the presentation has already begun. Each client computer is synchronized with the presentation in real time; once a new slide is shown on screen 44, the client user interface 70 will be updated accordingly.

The presenter computer or workstation 40 is preferably a laptop or personal computer which runs a presentation software application 600 that generates a presenter user interface 42. Using a dual monitor mode, the presenter computer 40 preferably directly provides a display input to LCD projector 46 so that is displays only the slide presentation while the presenter computer 40 display monitor 48 displays the entire presenter user interface 42.

FIG. 2 illustrates the interactive presentation system 11 according to a second embodiment of the invention. The interactive presentation system 11 of FIG. 2 is generally the same as the interactive presentation system 10 of FIG. 1, except that the application server computer 20, the database server 50, and the administrator computer 80 are each implemented using a dedicated computer. The application server computer 20, running server software 800, is shown equipped with an output display 22, input keyboard 24 and input mouse device 26, and it is operatively coupled to both the local network 30 and the external network 34. However, other suitable configurations may be used. The database server 50 is shown equipped with an output display 58, an input keyboard 54 and an input mouse device 56, and it is operatively coupled to both the local network 30 and database 52. However, other suitable configurations may be used. The administrator workstation is shown on a laptop computer, although other suitable configurations may be used. Administrator computer 80 is connected to local network 30, and it runs administrator computer software 700 that generates the administrative manager user interface 82.

The present invention may be embodied in part as computer readable code on computer readable media, including any computer data storage device such as magnetic storage devices, optical storage devices or ROM storage devices. The computer readable code may also be distributed over a network between computer systems so that it is stored and executed in a distributed fashion.

The application server computer 20, database server 50 and administrator computer 80 may be located in presentation room 12, or, as illustrated in FIG. 2, they may be located elsewhere. Although the application server computer 20, database server 50 and administrator computer 80 are shown in FIG. 2 to be collocated in room 14, they may be disposed in separate locations if desired.

FIGS. 2-6 illustrate one of many possible embodiments of the client user interface 70, presenter user interface 48, and administrative manager user interface 82, respectively. Each user interface 70, 48, 82 ideally employs standard windows-type display and control mechanisms including windows, client windows, frames, icons, buttons, check boxes, radio buttons, scroll bars, drop-down menus, pull-down menus, tabs, bar graphs, panes, panels, forms, slide bars, selection boxes, dialog boxes, text boxes, list boxes, menu bars, bar graphs, wizards, et cetera. The selection of the user interface components, and the placement thereof, may vary widely within the scope of the invention. The user interfaces are preferably constructed using an object-oriented programming language such as C++ for a Microsoft® Windows®, Linux® or Unix® operating system. Alternatively, the user interfaces may be created using hyper text mark-up language (HTML) for use with a browser software application. As user interface and object-oriented programming are well known in the field, the details of constructing the user interfaces 70, 48, 82 are not discussed further herein.

Referring to FIG. 3, one possible embodiment of the client user interface 70 is shown. User interface 70 is ideally designed and arranged for ease of use consistent with the type of client computer or workstation 60, 62, 64, 66, 68 being used. For example, if handheld devices are used, an alternate layout may be beneficial for being accommodated in the smaller available display area.

The client user interface 70 preferably includes a slide presentation window or panel 100 that displays the slide show. Although the slides are preferably displayed on large screen 44, by including slide presentation window 100 in client user interface 70, audience members are provided with an alternate view which may be easier to see. Additionally, presentation window 100 may be toggled between an ordinary size as shown in FIG. 1 and a full screen maximized size (not shown). When presentation window 100 is maximized, other features are not shown on client user interface 70, as the presentation window occupies nearly the entire screen.

Ideally, the slides displayed in the presentation window 100 of each client user interface 70 of client computer 60, 62, 64, 66, 68 are synchronized with the slides displayed at the main presentation screen 44. However, the client user interface 70 may optionally contain functionality that allows an audience member to individually pause the slide show in his or her slide presentation window 100 and navigate through the slide show as convenient. Such functionality allows the user to revisit a slide or view slides independently of the presenter's slide presentation pace, for example, if the audience member wishes or needs to take additional time for writing notes, questions or viewing the slide.

The optional slide show functionality is shown in FIG. 3. The client user interface 70 embodied in FIG. 3 includes a “Back” button 102 and a “Next” button 104 to toggle through the presentation slides in sequence. Clicking the “Back” or “Next” button 102, 104 has the effect of pausing the slide show at slide presentation window 100 independently of the slide show at main screen 44. However, the presentation system may include an option that prevents the “Next” button 104 from displaying slides that the presenter has not yet presented. Similarly, a “Pause” button 106 pauses the slide show at the currently displayed slide. Clicking a “Play” or “Resume” button 108 causes the currently displayed slide on main screen 44 to be displayed in slide presentation window 100 and the client user interface 70 to thence continue in synchronization with the slide presentation, unless again paused by the use of the “Pause,” “Back,” or “Next” buttons 106, 102, 104.

Client user interface 70 also preferably includes a text box 120 for the audience member to record notes. When the audience member clicks the “Save” button 122, the contents of notes box 120, tied to the slide displayed in slide presentation window 100 at the time, is transferred to database 52 (FIGS. 1-2) for later distribution to the audience member, either via the external network 34 or by a direct download to a user's USB flash storage device at the user computer 60, 62, 64, 66, 68 (FIGS. 1-2). In one embodiment, after notes are recorded, they may remain in text box 120 in a grayed-out status, which indicates the fact that the notes have been recorded. Thus an audience member may continue to view his or her notes during the presentation. Alternatively, the notes text box 120 may have its contents cleared upon recording, or other variations may be used. A “Clear” button 124 may be provided to clear the non-recorded portions of text box 120.

A “Download Presentation/Notes” button 180 and an “Email Presentation/Notes” button 185 are ideally provided for the user to request the presentation slides and user's recorded notes, keyed to the presentation slides. The presentation slides and user notes are preferably provided in an Adobe® Acrobat® pdf file format, but other suitable file formats may be used. When the “Download Presentation/Notes” button 180 is clicked, a standard operating system dialog box for saving files is presented to the user. The user may insert and select a removable USB storage device for saving the presentation/notes file(s). The corresponding user computer 60, 62, 64, 66, 68 transmits a request to application server computer 20 or database server 50 (FIGS. 1-2) to transfer the requested data to the user computer for writing to the removable storage device. When the “Email Presentation/Notes” button 185 is clicked, the user computer transmits a request to application server computer 20 or database server 50 (FIGS. 1-2) to email the presentation file(s) to the user's email account of record, the address of which is stored in database 52. The requested files are transmitted to the user over external network 34 (FIGS. 1-2) using Simple Mail Transfer Protocol (SMTP), for example.

Similar to notes text box 120, the client user interface 70 may include a question/comment text box 130. In one embodiment, entering text into question text box 130 and clicking the “Submit” button 132 immediately transmits that question or comment to be displayed at the presenter interface 42 (FIGS. 1-2). In another embodiment, entering text into question text box 130 and clicking the “Submit” button 132 transmits that question or comment to the administrator computer or workstation 80 for display at administrative manager user interface 82 where it is queued, along with questions and comments from all other attendees, for review by the administrative manager. The administrative manager edits and selects which questions and comments are to be forwarded to the presenter computer 40 for display at the presenter interface 42. In either embodiment, the question or comment is tied, correlated, or otherwise associated to the slide being displayed in the slide presentation window 100 and recorded in database 52 (FIGS. 1-2) for user and presentation analysis. A “Clear” button 134 may be provided to clear the unsent contents of question text box 130. Although the notes text box 120 and the question text box 130 are illustrated as separate text boxes, a combined text box with tab control to switch between the two functions may be alternatively used.

A resource view box 140 with tabbed control is ideally provided to allow the user to browse various resources. Selecting a “Reference” tab 142 causes the application server computer 20 (FIGS. 1-2) to transmit bibliographic data of references used for the presentation to user interface 70 for display in resource view box 140. The bibliographic data is preferably stored in database 52 and accessed via database server 50 (FIGS. 1-2). Selecting an “Events” tab 144 causes the application server computer 20 (FIGS. 1-2) to transmit a calendar of upcoming presentations, lectures and other events to user interface 70 for display in resource view box 140. The calendar of upcoming events is preferably stored in database 52 and accessed via database server 50 (FIGS. 1-2). Likewise, selecting a “Related Links” tab 146 causes the application server 20 (FIGS. 1-2) to transmit interest links related to the subject matter of the presentation to user interface 70 for display in resource view box 140. The Related Links data is preferably stored in database 52 and is accessed via database server 50 (FIGS. 1-2).

A “Request Samples” button 150 is optionally provided to allow the users to request samples. To select a particular sample out of several available samples, the request samples button 150, when selected, may be keyed to materials displayed in slide presentation window 100. Alternatively, an “Available Samples” tab 148 may be provided with resource view box 140 which can allow the user to select the desired samples. If no sample selection is required, for example, if only one default type of sample is offered, then the Request Samples button 150 may operate independently of slide presentation box 100 and resource view box 140. The Request Samples button 150 may also be used to request literature, catalogs, or additional materials.

The user interface 70 also preferably includes an Interest Level slide bar (or similar device) 160 and an Understanding Level slide bar (or similar device) 170. The user can adjust the setting of these feedback slide bars, which in turn is transmitted to the application server 20 and database server 50 (FIGS. 1-2). This feedback data is recorded in database 52, preferably on a user-by-user, slide-by-slide basis. The values of the interest levels and understanding levels for all users are averaged in real-time by applications server 20 and transmitted to the presenter computer 40 for display at the presenter user interface 42 (FIGS. 1-2) to allow the presenter to gauge his or her effectiveness in communicating to the audience. If there is an average high interest level but low understanding level, the presenter may wish to spend more time on a particular slide or topic. Conversely, if there is a low interest level and high understanding level, the material is probably adequately covered, and the presenter should move on to subsequent slides.

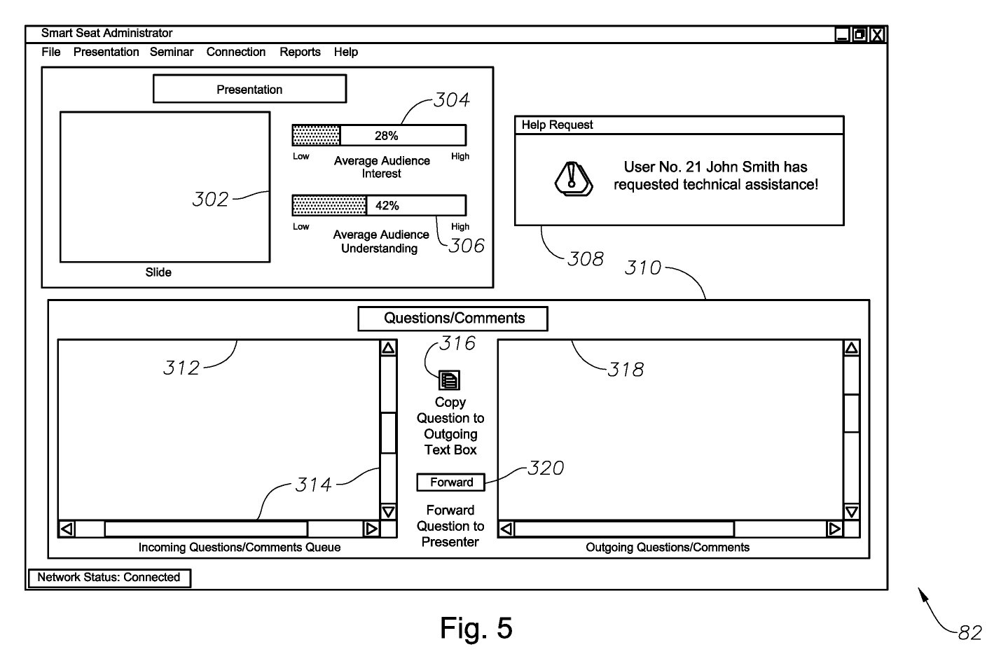

Referring to FIG. 3, the client user interface 70 may optionally include a “Help” button 190. When an attendee clicks “Help” button 190, the corresponding client computer 60, 62, 64, 66, 68 sends a request to the administrator computer 80, which in turn displays a help request message 308 at administrative manager user interface 82 (FIG. 5). The administrative manager may then send a technician to aid that attendee.

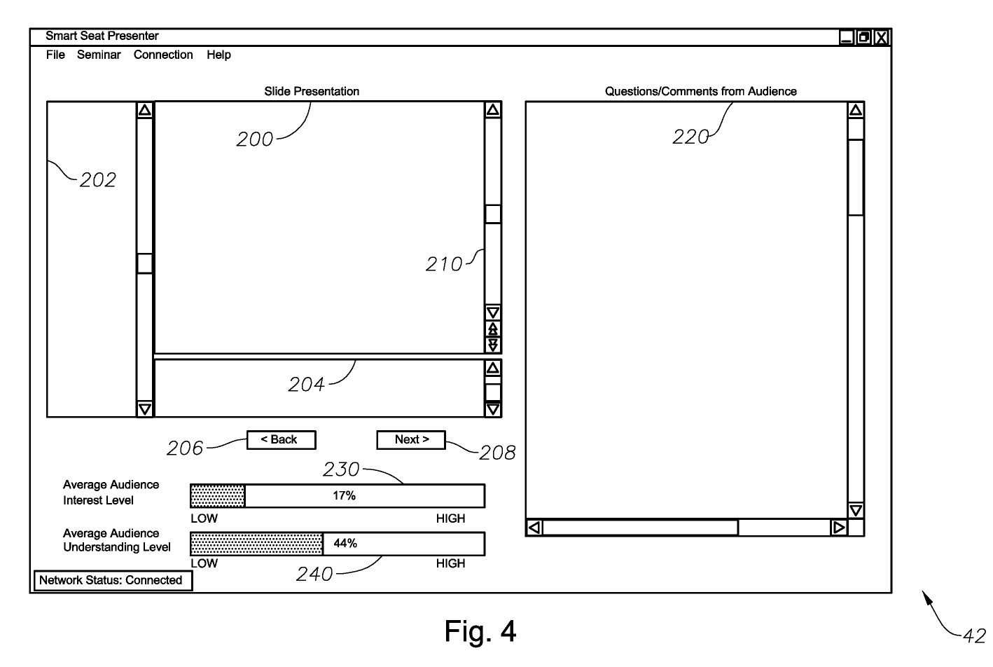

FIG. 4 illustrates one possible embodiment of a presenter user interface 42 at presenter computer 40. A slide presentation window 200 displays the current presentation slide from a slide show in a file format such as Microsoft® PowerPoint® or similar. A slide show outline scroll box 202 and/or a slide comment scroll box 204 may optionally be provided to aid the presenter. The slide currently displayed in slide presentation window 200 is also concurrently displayed at main screen 44 by projector 46 and at the slide presentation window 100 at the user interfaces 70 of all client computers 60, 62, 64, 66, 68 (unless a particular user has paused the slide show at his user interface 70, if that option is available). “Back” and “Next” buttons 206, 208 allow the presenter to advance slides or go back to previous slides during the presentation. Additionally, a scroll bar control 210 may be used to navigate the slide presentation and select slides.

A questions/comments window 220 displays questions and comments from the audience. In one embodiment, the audience's questions and comments are transmitted from the client computers 60, 62, 64, 66, 68 directly to the presenter computer 40 via application server computer 20 for display in the questions/comments window 220. In another embodiment, the audience's questions and comments are first transmitted by the application server computer 20 to the administrator computer 80, where they are reviewed, edited, and selectively forwarded to the questions/comments window 220 in presenter user interface 42 at presenter computer 40 by the administrative manager. For instance, if there are two or more substantially similar questions, only one might be forwarded. Furthermore, the administrative manager may wish to rephrase confusing questions before they are forwarded to the presenter. The questions and comments are queued in the questions/comments window 220 so that the presenter may address them as they appear or save them for answering at a logical break in or at the end of the slide presentation.

Referring to the presenter user interface 42 in FIG. 4, an average audience interest level feedback display 230 and an average audience understanding level feedback display 240 are provided to the presenter for gauging his performance. The feedback displays 230, 240 are preferably bar graph displays, but other suitable display types may be used. Each feedback display 230, 240 is preferably color coded so that it appears in red for low levels, white for normal levels, and green for high levels. The feedback displays 230, 240 receive feedback data from application server computer 20, which receives and averages the individual attendee feedback input from slide bar devices 160, 170 (FIG. 3) for transmitting to the presenter computer 40. Depending on the feedback, the presenter may wish to adjust the pace of the presentation. For instance, if the average audience interest level display 230 indicates low interest for a particular slide, the presenter may want to advance to the next slide. Conversely, if the average audience understanding level display 240 indicates low audience understanding for a particular slide, additional time may be needed explaining the material.

FIG. 5 illustrates an administrative manager user interface 82 for use during the slide presentation according to one embodiment of the invention. A slide window 302 displays the current presentation slide that is selected by the presenter and displayed in slide window 200 at presenter user interface 42 (FIG. 4) and at screen 44 (FIGS. 1-2). An average audience interest level feedback display 304 and an average audience understanding level feedback display 306 are also provided. The feedback displays 304, 306 show the results of the real-time statistical averaging performed by application server computer 20 of the individual attendee feedback input from slide bar devices 160, 170 (FIG. 3). The feedback displays 304, 306 contain the same feedback values as feedback displays 230, 240 of presenter user interface 42 at computer 40. The feedback displays 304, 306 are preferably bar graph displays, but other suitable display types may be used. Each feedback display 304, 306 is preferably color coded so that it appears in red for low levels, white for normal levels, and green for high levels.

When an attendee clicks “Help” button 190 at the client user interface 70 (FIG. 3), the corresponding client computer 60, 62, 64, 66, 68 sends a request via the application server computer 20 to the administrator computer 80 (FIGS. 1-2), which displays a help request message 308 at administrative manager user interface 82 (FIG. 5). The administrative manager may then send a technician to aid that attendee.

Referring to the administrative manager user interface 82 of FIG. 5, in one embodiment, a questions/comments panel 310 is provided for allowing the administrative manager to review questions submitted by the attendees before forwarding them to the presenter. An incoming questions/comments text box 312 displays attendee questions and comments. When an attendee types in question/comment text box 130 and clicks the “Submit” button 132 on client user interface 70 (FIG. 3), the corresponding client computer 60, 62, 64, 66, 68 transmits the text via application server computer 20 to administrator computer or workstation 80 (FIGS. 1-2) for display in the incoming questions/comments text box 312. The various questions and comments from the audience queue in the incoming text box 312. The administrative manager can scroll through the questions and comments using scroll bars 314. Administrative manager user interface 82 preferably includes a “Copy” button 316, which allows the administrative manager to copy selected (highlighted) questions or comments from the incoming text box 312 to an outgoing text box 318. Ideally, the text in outgoing text box 318 may be freely edited by the administrative manager. When clicked, a “Forward” button 320 causes the administrator computer or workstation 80 to send the contents of the outgoing questions/comments text box 318 via application server computer 20 to the presenter computer 40 for display in questions/comments window 220 at presenter user interface 42.

In one embodiment, after questions/comments are forwarded, they may remain in outgoing text box 318 in a grayed-out status, which indicates that the questions/comments have been forwarded. Thus, the administrative manager may continue to view the forwarded questions and comments during the presentation. Alternatively, the outgoing text box 318 may have its contents cleared upon forwarding, or other variations may be used.

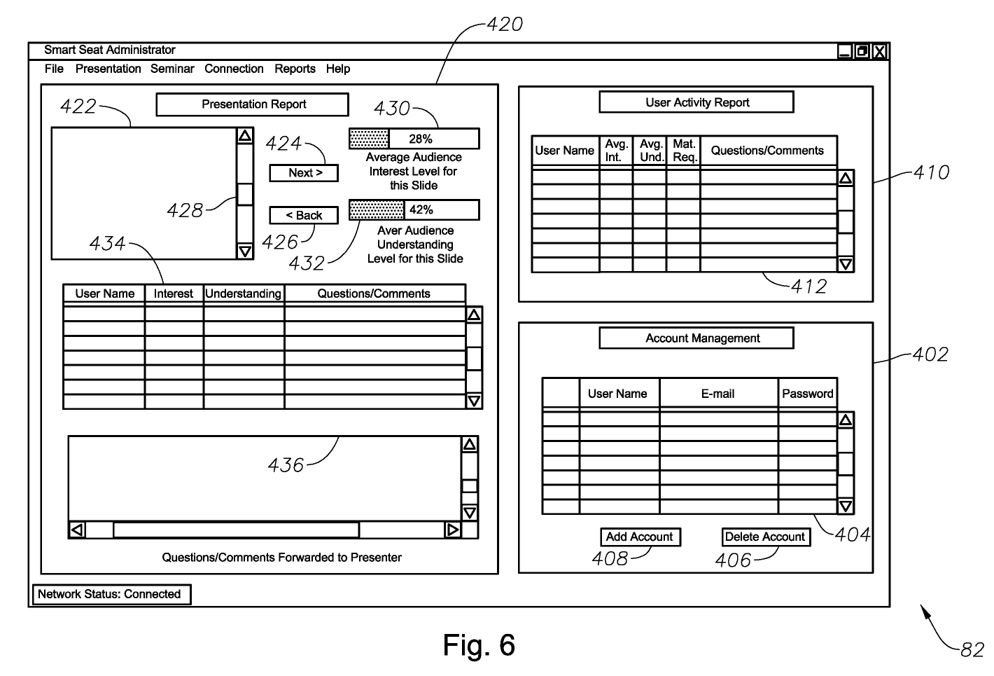

FIG. 6 illustrates an administrative manager user interface 82 layout for use both prior to and subsequent to the slide presentation according to one embodiment of the invention. An account management panel 402 is preferably provided that includes a scrollable account table 404 for listing values of names, email addresses, user passwords, et cetera, retrieved from database 52 (FIGS. 1-2). User accounts are preferably deleted from database 52 (FIGS. 1-2) by selecting (highlighting) one or more user accounts in the account table 404 and clicking the “Delete Account” button 406. An “Add Account” button 308 is provided, which when clicked, opens a dialog box or wizard (not shown) that prompts for inputting user account information. The inputted data, preferably including user name, email address, and user password, are then transferred from administrator computer 80 to database server 50 for storage in database 52. This account information is used to provide each attendee unique access to the interactive presentation system 10, 11 by initial login screens (not shown) at client computers 60, 62, 64, 66, 68 (FIGS. 1-2).

The administrative manager user interface 82 of FIG. 6 may include extensive post-slide presentation data for reviewing and improving presentations and for follow up with attendees. In one embodiment, the interactive presentation system 10, 11 (FIGS. 1-2) tracks and records individual attendee activity information including interest and understanding feedback on a per slide basis, requested samples or material, and questions or comments on a per slide basis. However, in another embodiment, any or all of this attendee activity information can be kept anonymous by the system 10, 11, if desired. FIG. 6 illustrates an administrative manager user interface 82 wherein the attendee activity information is tracked and recorded. Such data may be useful for follow-up contact with an attendee after the presentation.

For instance, a user activity report panel 410 provides a scrollable post-presentation user activity table 412 for listing values retrieved from database 52 (FIGS. 1-2). For each user, the displayed values preferably include the user's name and his or her average interest and understanding levels for the entire slide presentation (computed by the application server computer 20 (FIGS. 1-2) from the individual feedback values input by the user using slide bars 160, 170 in client user interface 70 (FIG. 3) at the corresponding client computer 60, 62, 64, 66, 68 (FIGS. 1-2)). User activity table 412 also displays any literature or samples requested by the user via the “Request Samples” button 150 and/or optional “Available Samples” tab 148 and any question or comment submitted via questions/comments text box 130 (FIG. 3) in client user interface 70 (FIG. 3) at the corresponding client computer 60, 62, 64, 66, 68 (FIGS. 1-2).

A presentation report panel 420 provides a slide-by-slide post-presentation analysis. A slide presentation window 422 displays slides from a slide show file of a previous presentation. “Next” and “Back” buttons 424, 426 allow the administrator to sequence through a slide show file. Alternatively, a scroll bar 428 may be used to quickly move through a slide show file. Bar graphs 430, 432 for average audience interest and understanding levels, a scrollable table 434 for user information, and a scrollable text window 436 for questions and comments that were forwarded to the presenter by the administrator during the presentation all display post-presentation data from database 52 (FIGS. 1-2) on a per slide basis. In other words, as the slide displayed in slide presentation window 422 is changed by use of the “Next” button 424, “Back” button 426, or scroll bar 428, the information displayed in presentation report panel 420 likewise changes to correspond to the displayed slide.

The average audience interest level bar graph 430 displays the average of all users' interest level feedback for the slide displayed in window 422 (calculated by application server computer 20 from data stored in database 52 (FIGS. 1-2) from the users' input using slide bar 160 on client user interface 70 (FIGS. 3) at client computers 60, 62, 64, 66, 68 (FIGS. 1-2) while that slide was displayed during the presentation). Likewise, the average audience understanding level bar graph 432 displays the average of all users' understanding level feedback for the slide displayed in window 422. The interactive presentation system 10, 11 (FIGS. 1-2) may optionally include a user information table 434 that displays, on a user-by-user basis for the slide displayed in window 422, individual interest and understanding levels and any user comments or questions inputted by the user at client user interface 70 (FIG. 3) when that slide was displayed during the presentation. A scrollable text window 436 is preferably provided to display the questions and comments for the slide displayed in window 422 that were forwarded to the presenter by the administrative manager (using the questions/comments panel 310 on the administrative user interface 82 of FIG. 5) when that slide was displayed during the presentation.

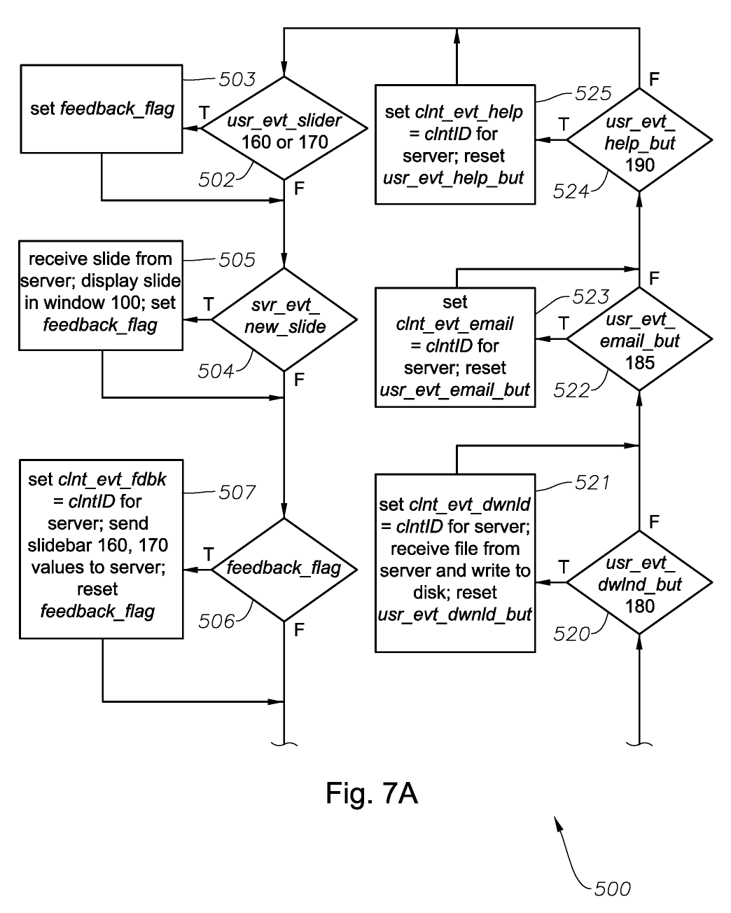

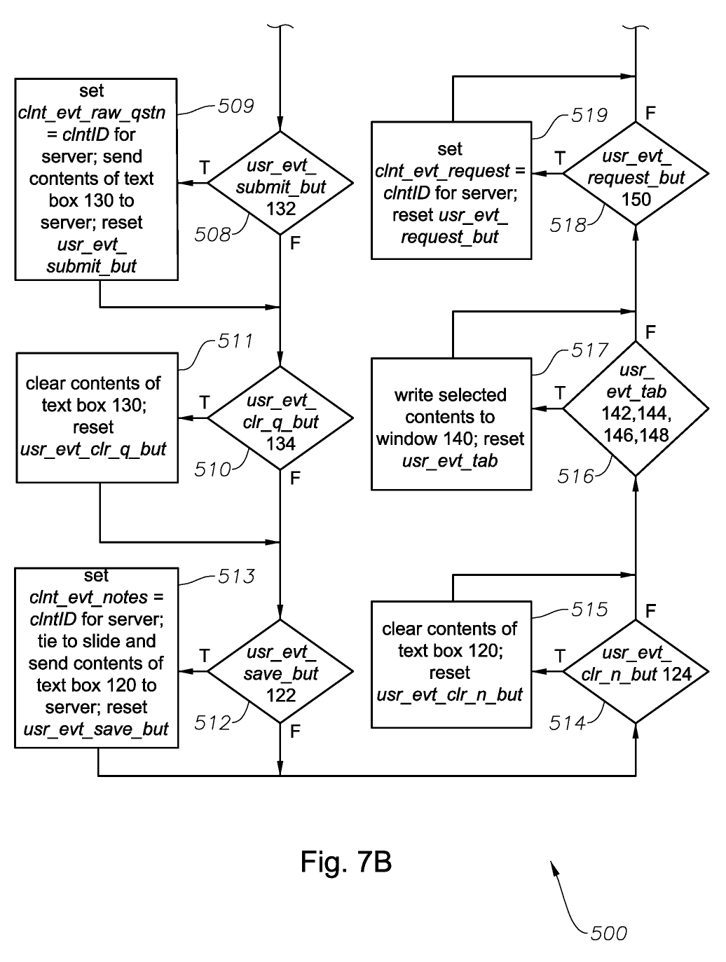

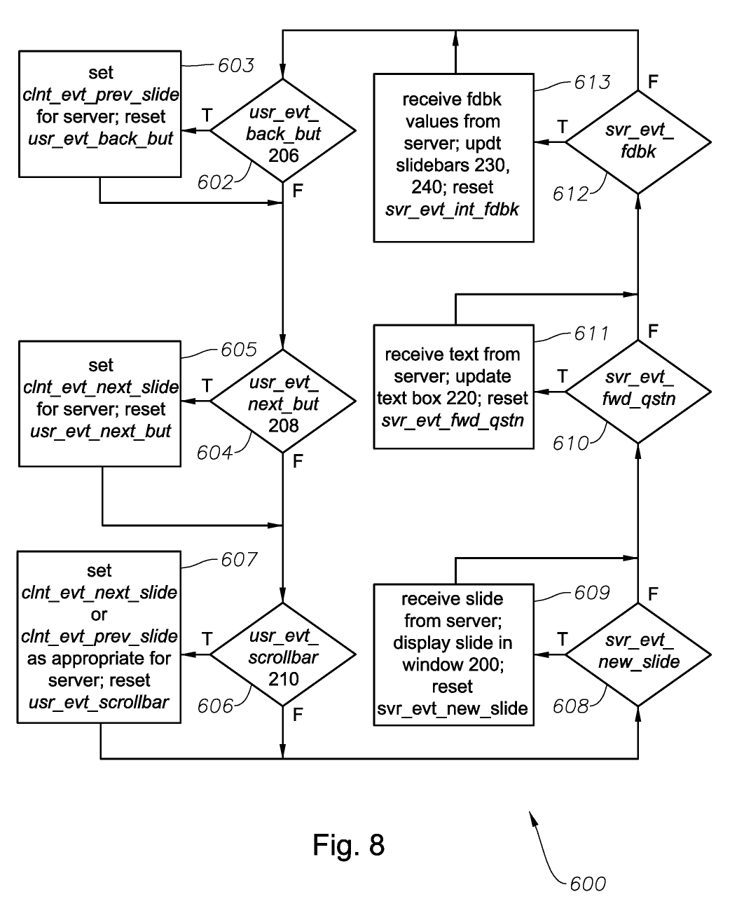

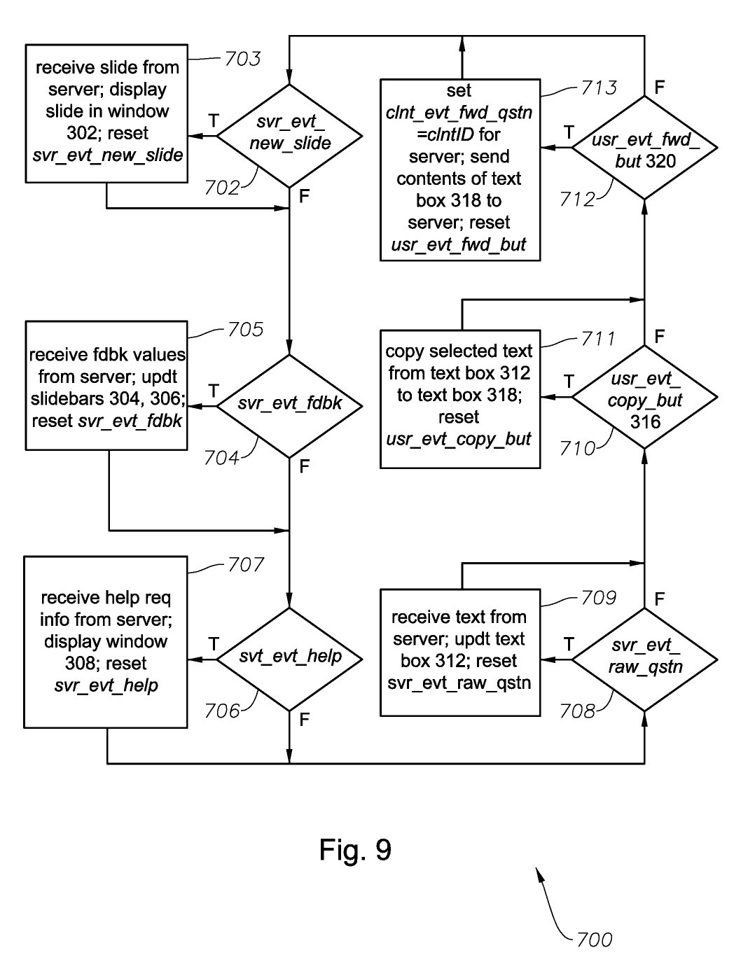

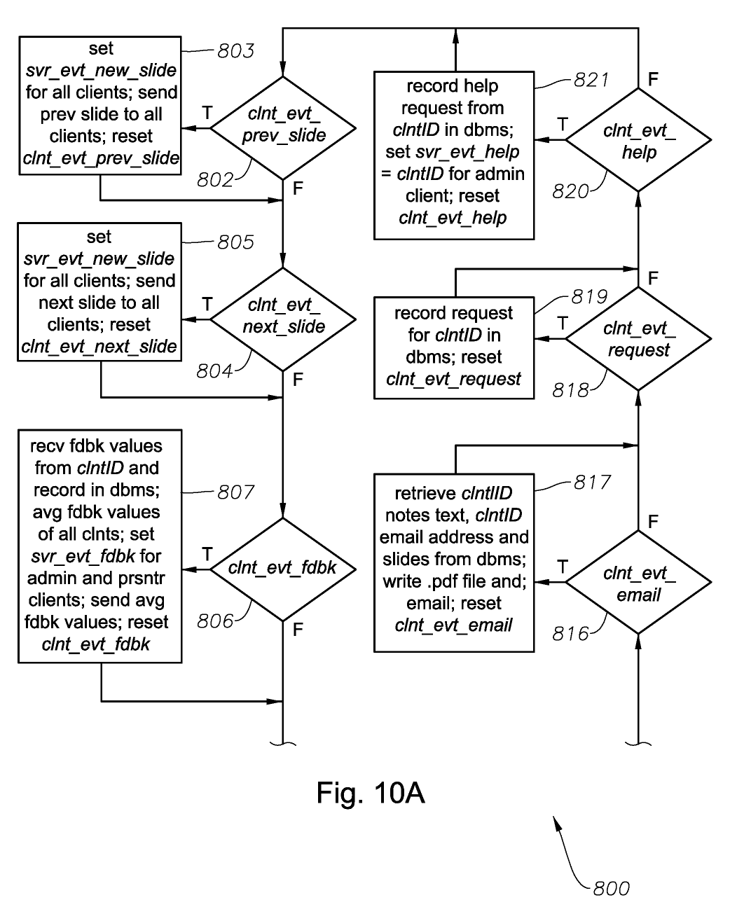

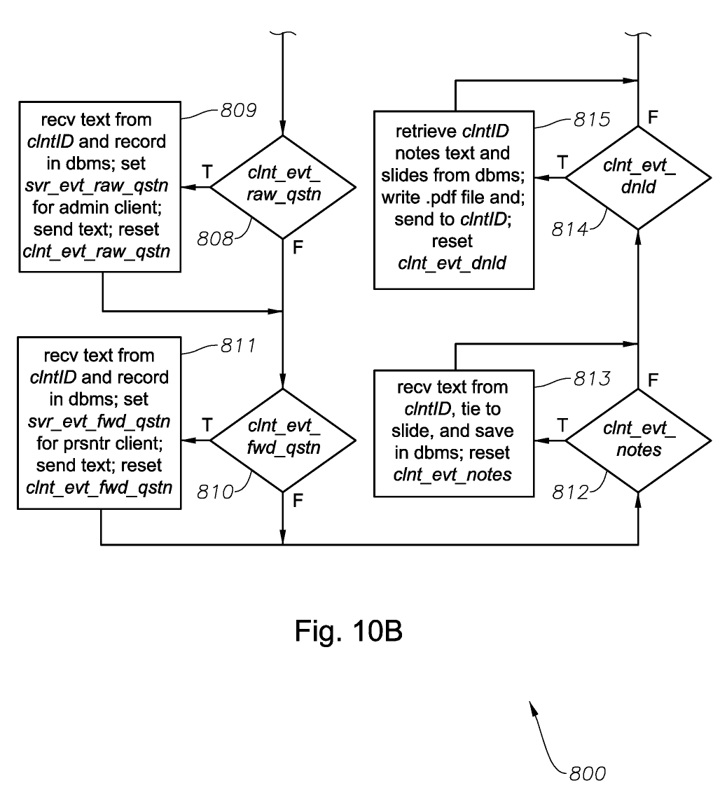

FIGS. 7-10 are simplified schematic flowcharts illustrating one possible embodiment of the structure of software, and the functionality inherent therein, for the presentation systems 10 and 11 of FIGS. 1-2. FIG. 7 corresponds to the software program 500 running on the client computers or workstations 60, 62, 69, 66, 68. FIG. 8 corresponds to the software program 600 running on the presenter computer or workstation 40. FIG. 9 corresponds to the software program 700 running on the administrator workstation or computer during the presentation, and FIG. 10 corresponds to the software program 800 running on the application server computer 20. FIGS. 7-10 employ a standard flow chart convention where decisions are represented by a rhomboidal symbol and actions are represented by a rectangular symbol. The program logic flow between the various decisions and actions is depicted by arrows. For instance, each decision rhombus contains an interrogatory. If the interrogatory, when evaluated, is true, the program flow is indicated by the arrow leading from that rhombus designated with a “T.” Likewise, if the interrogatory is false, the program flow is indicated by the arrow leading from that rhombus labeled with an “F.”

The flow charts of FIGS. 7-10 also employ a nomenclature convention for naming program variables. The prefix “svr_evt” in a variable name indicates that the variable represents whether or not a particular event triggered by the application server computer 20 has occurred. The prefix “usr_evt” in a variable name indicates that the variable represents whether or not a particular event triggered by the user of the local machine has occurred, e.g., whether the user has clicked a particular button. Likewise, the prefix “clnt_evt” in a variable name indicates that the variable represents the occurrence of a particular event triggered by any computer served by application server computer 20, i.e., any client computer 60, 62, 64, 66, 68, the presenter computer 40, the administrator computer 80, or the database server 50. When a particular event occurs, that event variable is set to TRUE. Generally, a variable is evaluated as FALSE if it is equal to zero, whereas it is TRUE if it is equal to any positive value. However, other conventions may be employed. The carious software programs 500, 600, 700, 800 communicate and cooperate with each other over local network 30 or external network 34 using, for example, Transmission Control Protocol (TCP) client-server software architecture. As client-server computer programming is well known in the art, the programming details are not further discussed herein.

The simplified flowcharts of FIGS. 7-10 show only basic functionality of each program 500, 600, 70, 800. Each program preferably runs as a loop, waiting for particular events to occur before performing responsive actions. After an action is performed, the event variable that triggered it is reset so that the action will not be performed again until the event reoccurs. The entry and exit points of the loop structure are not indicated for simplicity.

Referring to FIG. 7, the basic program structure for the software 500 running as a separate instance on each of the client computers 60, 62, 64, 66, 68 is shown. At decision rhombus 502, the software 500 considers whether the user has changed a feedback value by adjusting interest feedback level slide bar 160 or understanding feedback level slide bar 170 (FIG. 3). If the user has adjusted one of these slide bars, a feedback flag variable (feedback_flag) is set to TRUE as depicted in action box 503. The program 500 then proceeds to consider whether the application server computer 20 has indicated that a new slide is to be displayed, as depicted by decision rhombus 504. If the new slide event variable (srv_evt_new_slide) has been set to TRUE by application server computer 20, then the software 500 directs the corresponding client computer 60, 62, 64, 66, 68 (FIGS. 1-2) to receive the new slide data from application server computer 20, display the new slide in slide window 100 (FIG. 3), and set the feedback flag variable (feedback_flag) to TRUE, as depicted in action box 505. At decision rhombus 506, the feedback flag variable is evaluated. If the feedback flag variable has been set to TRUE at either action box 503 or action box 505, then, per action box 507, a client event feedback variable (clnt_evt_fdbk) is set equal to a unique computer identification number (clntID) to indicate to the application server computer 20 (see decision rhombus 806, FIG. 10) that the client computer has feedback information to send. As shown at action box 507 and action box 807 (FIG. 10), client computer 60 and application server computer 20 coordinate to transmit the values of slide bars 160, 170 from the client computer to application server computer 20. Software 500 then resets the feedback flag (feedback_flag) to FALSE.

The software 500 next considers at decision rhombus 508 whether the user has clicked the “Submit” button 132 (FIG. 3). If so, the user event submit button variable (usr_evt_submit_but) evaluates as TRUE, and per action box 509, the software transmits the contents of question/comment text box 130 (FIG. 3) to server computer 20 in a manner very similar to the way the feedback values are transmitted, as described above. At decision rhombus 510, if the user clicked the “Clear” button 134 (FIG. 3), the contents of question/comment text box 130 (FIG. 3) is cleared and the triggering user event variable (usr_evt_clr_q_but) is reset, as shown by action box 511.

The software 500 then considers at decision rhombus 512 whether the user has clicked the “Save” button 122 (FIG. 3). If so, the user event save button variable (usr_evt_save_but) evaluates as TRUE, and per action box 513, the software transmits the contents of notes text box 120 (FIG. 3) to server computer 20. At decision rhombus 514, if the user clicked the “Clear” button 124 (FIG. 3), the contents of notes text box 120 (FIG. 3) is cleared and the triggering user event variable (usr_evt_clr_n_but) is reset, as shown by action box 515.

Referring to decision rhombus 516 and action box 517, the “References” tab 142, the “Upcoming Events” tab 144, the “Related Links” tab 146, and the “Available Samples” tab 148 are monitored for user action. Preferably, the content to be displayed for each selected tab is initially communicated to each client computer 60, 62, 64, 66, 68 by application server computer 20 (FIGS. 1-2) when the user initially logs into the system. Because this data is relatively static, it is not generally necessary to repeatedly query the application server computer for these user events. However, hypertext links to the internet may be handled by applications server computer 20 acting as a proxy server.

In a similar manner, decision rhombuses 518, 520, 522 and 524, and corresponding action boxes 519, 521, 523 and 525, depict the remaining basic functionality of software 500. The “Send Request” button 150, the “Download” button 180, the “Email” button 185, and the “Help” button 190 are all monitored for user action, and appropriate actions, including triggering events to occur in application server computer 20, are performed. These features are preferably capable of being enabled or disabled on the client interface 70 (FIG. 3) by the administrative manager.

Referring to FIG. 8, the basic program structure for the software 600 running on presenter computer 40 is shown. At decision rhombus 602, the software 600 considers whether the presenter has clicked the “Back” button 206 (FIG. 4). If so, a client event previous slide variable (clnt_evt_prev_slide) is set to indicate to the application server computer 20 that a previous slide should be displayed. The server evaluates the client event previous slide variable (clnt_evt_prev_slide) in decision rhombus 802 (FIG. 10), and it sends the previous slide to all client computers by setting the server event new slide variable (svr_evt_new_slide) to TRUE as represented by decision rhombus 608 and action box 609 and as described above with reference to FIG. 7. Similar program functionality for navigation through the slide presentation is provided at decision rhombuses 604, 606 and action boxes 605, 607.

Decision rhombus 610 and corresponding action box 611 are used to receive and display questions and comments from the server computer 20, and rhombus 612 and corresponding action box 613 are used to receive and display averaged feedback values in bar graphs 230, 240 (FIG. 4).

FIG. 9 shows the basic program structure for the software 700 running on administrator computer or workstation 80. Decision rhombus 702 and corresponding action box 703 function to display the slide presentation in slide window 302 (FIG. 5). Decision rhombus 704 and action box 705 function to display the average feedback values at bar graphs 304, 306 (FIG. 5). In decision rhombus 706, software 700 evaluates a server event help variable (svr_evt_help). If the server event help variable is TRUE, per action box 707, software 700 displays a help alert window 308 at administrative manager user interface 82 (FIG. 5), identifying the computer or user that has requested assistance. The server event new question variable (svr_evt_raw_qstn) at decision element 708 is set to TRUE (and preferably set equal to a client computer or user identification number (clntID)) by application server computer 20 when a question or comment has been submitted by an audience member. Action box 709 shows that when a question or comment has been submitted, the text of the question or comment is transferred from the application server computer 20 to the administrator computer or workstation 80 for display in text box 312 of administrative manager user interface 82 (FIG. 5). The administrator can copy the selected text of raw unedited questions and comments in text box 312 to text box 314 by clicking “copy” button 316 in user interface 82 (FIG. 5). Doing so sets the user event copy button variable (usr_evt_copy_but) to TRUE. When the user event copy button variable is evaluated, as shown in decision rhombus 710, a TRUE value instructs the software 700 to copy the selected text, as shown in action box 711. The administrator edits the questions and comments in text box 314 prior to forwarding them to the presenter computer 40 for display in text box 220 of presenter user interface 42. When the administrator clicks the “Forward” button 320 (FIG. 5), decision rhombus 712 causes the software code in action box 713 to be executed, which effects the transfer of the edited text from text box 318 of administrator computer 80 to text box 220 of presenter computer 40.

FIG. 10 shows the basic program structure for the software 800 running on the application server computer 20. Referring to decision rhombuses 802, 804 and action boxes 803, 805, when the presenter clicks the “Back” or “Next” button 206, 208 or operates scrollbar 210 (FIG. 4), the presenter computer software 600 sets the appropriate client event previous slide variable (clnt_evt_prev_slide) or client event next slide variable (clnt_evt_next_slide) to TRUE (refer to decision rhombuses 602, 604, 606 and action boxes 603, 605, 607, FIG. 8). Application server computer software 800 evaluates these variables and retrieves the appropriate slide from database 52 for transmission to the various client computers 60, 62, 64, 66, 68, the presenter computer 40, and the administrator computer 80. As shown by action boxes 803, 805, software 800 sets the server event new slide variable (svr_evt_new_slide) to TRUE, which triggers the various client computers 60, 62, 64, 66, 68, the presenter computer 40, and the administrator computer 80 to receive the slide data from application server computer 20 (refer to flow chart elements 504, 505, 608, 609, 702, and 703, FIGS. 7, 8, and 9, respectively).

Referring to decision rhombus 806 and associated action box 807, when any audience member adjusts a feedback slide bar 160, 170 (FIG. 3), or for every new slide, the client event feedback variable (clnt_evt_fdbk) is set to TRUE (refer to action boxes 503, 505, 507, FIG. 7). For each instance of feedback, software 800 causes application server computer 20 to receive the feedback values and record them in database 52. Furthermore, software 800 directs the averaging of the feedback values and transmission of the average values to the presenter computer 40 (FIGS. 1-2), setting the server event feedback variable (svr_evt_fdbk) to TRUE to trigger the presenter computer software 600 (FIG. 8) to receive the values.

Flow chart elements 808, 809 act to record raw unedited questions and comments from audience members in database 52 and to transfer them to administrator computer 80 (FIGS. 1-2) for display in text box 312 (FIG. 5). Likewise, flow chart elements 810, 811 act to record edited questions from text box 318 (FIG. 5) in database 52 and to forward them to presenter computer user interface 42.

When an audience member clicks the “Save” button 122 to record his or her notes, the client event notes variable (clnt_evt_notes) is set to TRUE, as described above with reference to flow chart elements 512, 513 of FIG. 7. Then, when the client event notes variable is evaluated at decision rhombus 812, the program flow is directed to action box 813. The application server computer 20 is directed to receive the audience member's notes, to correlate the notes to the present slide being displayed, and to save them in database 52. Flow chart elements 814, 815, 816, and 817 describe the structure of the software 800 that functions to provide an audience member with a copy of the slide presentation and all of his notes correlated thereto. These flowchart elements 814, 815, 816, 817 cooperate with flowchart elements 520, 521, 522, and 523 of FIG. 7 to transfer the slide presentation and notes to the requesting audience member via email or by downloading to a removable storage device.

Referring to FIG. 10, decision rhombus 820 detects when a client computer 60, 62, 64, 66, 68 has set a client event help variable (clnt_evt_help) to TRUE (refer to flow chart elements 524, 525 of FIG. 7) by equating the variable to a unique computer identification number (clntID) in response to an audience member clicking the “Help” button 190 on client user interface 70 (FIG. 3). In response, as shown by action box 821, application server computer forwards the request to the administrator computer or workstation 80 (refer to flowchart elements 706, 707 of FIG. 9).

FIGS. 7-10, and the embodiments 10, 11 generally described in the specification, show that various functions of the system are performed by certain computers running certain software. However, system functions may be performed by any suitable computer. For example, the function of correlating an audience member's notes to the slide being displayed when the notes are recorded is described as occurring at application server computer 20 running software 800. However, the correlation could equally occur at each client computer 60, 62, 64, 66, 68, with appropriate correlation data transferred from the client computer to the server for storage. Likewise, the averaging of user feedback is described as occurring at application server 20, but the averaging function can also per performed at the presenter computer 40 or the administrator computer 80, for example.

Similarly, the embodiments describe the preferred embodiment for a presentation system adapted for use with an audience that is present in the same room as the presenter. However, the system may also be used in situations where audience members are not present with the presenter through the use of the internet and/or video-teleconferencing technology.

The Abstract of the Disclosure is written solely for providing the United States Patent and Trademark Office and the public at large with a means by which to determine quickly from a cursory inspection the nature and gist of the technical disclosure, and it represents solely a preferred embodiment and is not indicative of the nature of the invention as a whole.

While some embodiments of the invention have been illustrated in detail, the invention is not limited to the embodiments shown; modifications and adaptations may occur to those skilled in the art. Such modifications and adaptations are in the spirit and scope of the invention as set forth herein:

What is claimed is:

1. A system (10, 11) for facilitating an interactive presentation by a presenter to a plurality of audience members, said presentation including a visual display of a plurality of electronically-stored presentation slides to said plurality of audience members, the system comprising:
a plurality of client computers (60, 62, 64, 66, 68), each said client computer associated with and in the presence of one of said plurality of audience members and including client computer software (500) and a client user interface (70) that are arranged and designed for recording a thought of an associated audience member;
an application server computer (20) operatively coupled to said plurality of client computers by a network (30, 34) and including a server software application (800) arranged and designed to receive said recorded thought from said client computer via said network;
said system arranged and designed for establishing correlation of said thought to one of said plurality of presentation slides and to provide said plurality of presentation slides and said thought in correlation therewith to said associated audience member.

2. The system of claim 1 further comprising:
a database (52) arranged and designed for storing data pertaining to said plurality of audience members and said thought.

3. The system of claim 1 further comprising:
a presenter computer (40) including presenter computer software (600) and a presenter user interface (42), said presenter computer operatively coupled to said plurality of client computers and said application server by said network, said presenter computer arranged and designed to receive a communication of one of said plurality of audience members over said network, said presenter user interface arranged and designed to display said communication of one of said plurality of audience members to said presenter.

4. The system of claim 3 wherein:
each of said plurality of client computers is arranged and designed to record a first input by said associated audience member;
said system is arranged and designed to compute a statistical analysis of said plurality of first inputs and to display a result of said statistical analysis to said presenter user interface.

5. The system of claim 2 further comprising:
an administrator computer (80) including administrator computer software (700) and an administrative manager user interface (82), said administrator computer operatively coupled to said plurality of client computers and said application server by said network,
said administrative manager user interface arranged and designed to query and access said database and to display data obtained therefrom.

6. The system of claim 3 further comprising:
an administrator computer (80) including administrator computer software (700) and an administrative manager user interface (82), said administrator computer operatively coupled to said plurality of client computers and said application server by said network, said administrator computer arranged and designed to receive said communication of one of said plurality of audience members from one of said plurality of client computers over said network,
said administrative manager user interface designed and arranged to display said communication of one of said plurality of audience members and to allow selection and editing of said communication of one of said plurality of audience members,
said administrator computer arranged and designed to transmit an edited and selected communication of one of said plurality of audience members from said administrative manager user interface to said presenter computer.

7. The system of claim 1 wherein:
said application server computer and said server software application are arranged and designed to correlate said thought of said associated audience member to one of said plurality of presentation slides.

8. The system of claim 1 wherein:
each of said plurality of client computers and said client computer software are arranged and designed to correlate said thought of said associated audience member to one of said plurality of presentation slides, and
said application server computer and server software application are arranged and designed to receive said thought of said associated audience member and correlation data from each of said plurality of client computers.

9. The system of claim 1 wherein:
said plurality of audience members are in the presence of said a presenter; and
said network is a local area network.

10. The system of claim 1 wherein:
said system is arranged and designed to email said associated audience member with a copy of said plurality of presentation slides and said thought correlated therewith.

11. The system of claim 4 wherein:
said plurality of first inputs reflects a level of interest or understanding by said plurality of audience members.

12. A pharmaceutical or medical presentation and marketing system (10, 11) for facilitating an interactive pharmaceutical or medical presentation by a presenter to a plurality of audience members disposed generally therewith, said presentation including a visual display of a plurality of electronically-stored presentation slides to said plurality of audience members, the system comprising:
a plurality of client computers (60, 62, 64, 66, 68), each said client computer associated with and in the presence of one of said plurality of audience members and including client computer software (500) and a client user interface (70) that are arranged and designed for recording a note of an associated audience member;
an application server computer (20) operatively coupled to said plurality of client computers by a local network (30) and operatively coupled to an external network of computers, said application server computer including a server software application (800) arranged and designed to receive said recorded note from said client computer via said local network;
said system arranged and designed for establishing correlation of said note to one of said plurality of presentation slides and to provide said plurality of presentation slides and said note in correlation therewith to said associated audience member.

13. The system of claim 12 further comprising:
a database (52) arranged and designed for storing data pertaining to said plurality of audience members and said note, and
an administrator computer (80) including administrator computer software (700) and an administrative manager user interface (82), said administrator computer operatively coupled to said plurality of client computers and said application server by said local network,
said administrative manager user interface arranged and designed to query and access said database and to display data obtained therefrom.

14. The system of claim 12 further comprising:
a presenter computer (40) including presenter computer software (600) and a presenter user interface (42), said presenter computer operatively coupled to said plurality of client computers and said application server by said local network, said presenter computer arranged and designed to receive a question of one of said plurality of audience members over said local network, said presenter user interface arranged and designed to display said question of one of said plurality of audience members to said presenter.

15. The system of claim 14 wherein:
each of said plurality of client computers is arranged and designed to record a first input by said associated audience member;
said system is arranged and designed to compute a statistical analysis of said plurality of first inputs and to display a result of said statistical analysis to said presenter user interface.

16. The system of claim 14 further comprising:
an administrator computer (80) including administrator computer software (700) and an administrative manager user interface (82), said administrator computer operatively coupled to said plurality of client computers and said application server by said local network, said administrator computer arranged and designed to receive a question of one of said plurality of audience members over said network,
said administrative manager user interface designed and arranged to display said question of one of said plurality of audience members and to allow selection and editing of said question of one of said plurality of audience members,
said administrator computer arranged and designed to transmit an edited and selected question from said administrative manager user interface to said presenter computer.

17. A method for facilitating an interactive presentation by a presenter to a plurality of audience members in attendance therewith, the method comprising the steps of:
providing each of said plurality of audience members with an associated client computer;
displaying visually a plurality of electronically-stored presentation slides to said plurality of audience members;
recording a note by one of said plurality of audience members on said associated client computer;
correlating said note to one of said plurality of presentation slides which is displayed when said note is recorded;
transmitting said note to an application server computer via a local network; and then
transmitting said note and said one of said plurality of presentations slides by said application server computer to said one of said plurality of audience members.

18. The method of claim 17 further comprising the step of:
transmitting said note and said one of said plurality of presentations slides by said application server computer to said one of said plurality of audience members via an external network.

19. The method of 17 further comprising the steps of:
transmitting a communication of a second of said plurality of audience members from said associated client computer to an administrator computer;
editing said communication of a second of said plurality of audience members by an administrative manager at said administrator computer; and
forwarding said edited communication by said administrative manager from said administrator computer to a presentation computer for display to said presenter.
